(19) United States
(12) Patent Application Publication
(10) Pub. No.: US 2013/0110572 A1
(43) Pub. Date: May 2, 2013

(54) Internet or Computer system and method for configuring, bidding, analyzing, and contracting products. For construction projects and other multi part products.

(71) Applicant: Timothy Edward Eagan, Dulles, VA (US)

(72) Inventor: Timothy Edward Eagan, Dulles, VA (US)

(73) Assignee: Sierra Development Inc., Dulles, VA (US)

(21) Appl. No.: 13/286,260

(22) Filed: Nov. 1, 2011

(51) Int. Cl. G06Q 10/06

(52) U.S. Cl. 705/7.23

(57) ABSTRACT

A system and method for a computerized purchasing system. The design of products or projects consists of descriptions that are converted into a coded takeoff element(s). The elements are further defined by linked scopes of work descriptions and can include contract language. Contractor and vendor codes are linked to the system codes. Bids are requested in prescribed formats and when returned are processed into the coded takeoff elements. From the design coded takeoff elements and the returned bid data we get, pro-forma budgets, actual contracted budgets, automated reconfigurable billings, standardized product elements with unitized costs, automated pricing updates, and contracts.

### COPYRIGHT NOTICE

A portion of the disclosure of this document contains material which is subject to copyright protection. The copyright owner has no objection to the facsimile reproduction of the patent document or the patent disclosure, as it appears in the Patent and Trademark Office patent file or records, but otherwise reserves all copyrights whatsoever.

### FIELD OF THIS EMBODIMENT

The field of this embodiment is the design and methodology for product design, classifying data, doing takeoffs, bidding, and awarding contracts. Multi-part products in this embodiment relates to residential construction.

### BACKGROUND

The embodiment that applies to the contracting for construction projects will be described. This area has need for improvement. Efficiency needs in residential homebuilding will be outlined which can also be applied to remodel work, as well as commercial construction. Any difficult multi-part product is also a candidate for this application.

There is much inefficiency in the contracting process for construction of homes. Incomplete or conflicting information in the plans, for instance are a major concern. Often construction plans are in place without specifications. When the plans do have specifications available, many times they are very vague or contain conflicting details. It is also likely that required information needed by home buyers is incomplete.

Larger homebuilding contractors offer their customers homes for sale with many available options. Each contractor (homebuilder) has its own style of describing and coding the project. This is also true of the bidding vendors (suppliers, manufacturers, and subcontractors). They each have their own method of doing the takeoff for an option in order to arrive at the bid price. The diversity of style and approach between the architects, contractors, vendors, and manufactures usually results in inefficiencies in contracting. The use of computers in addressing inefficiencies and solving these problems has proven to be essential.

As demonstrated in the prior art, the process of bidding and contracting has many software offerings focusing on improving current situations. There are numerous software systems utilized for collecting information about customers and vendors. Additionally, gathering documents on a web site to disseminate has been done in an assortment of ways. The use of planrooms and data collection sites has been very helpful. There are many examples of estimating software using formulas to calculate the cost of items and assemblies. Spreadsheets, for example continue to be used in a variety of circumstances as a primary tool for project estimates.

A standard contracting process may contain the following aspects. First, plans and perhaps specifications are developed. Second, the information is sent to various vendors who will bid on their particular trade areas (sometimes described as cost codes). The project documents should completely outline the specifications and also describe the scope of the work that is how the work will be implemented. The project is categorized by work functions (cost codes). The vendors will each do their takeoffs reflecting different levels of detail applying differing markups and margins for each work function. The vendors will then return the bid prices to the contractor, hopefully in a fashion that requires as little processing as possible. The degree of complexity in the work function and detail of returned bid information will dictate how easy it will be to compare one vendor's bid to another's as well as comparing the bids to the pro-forma budget.

As described in the purchasing process, it is evident that many people are doing the same work in many different ways for the results they need. The duplication is increased if a homeowner gets bids from several homebuilders. Even if a home is purchased from a production homebuilder with an inventory there are large areas of inefficiencies. If specifications and/or scope of work are missing or lacking in detail, then the homebuilders and vendors will assume what is to be provided. Each vendor for each homebuilder will be bidding on a different scope of work unless an exact scope is provided.

Customers will receive different levels of detail on what they are buying from each homebuilder they are considering, causing confusion. Providing fewer options until the contract is signed makes it easier for contractors to bid. This adds confusion to the customer in comparing contractors bids if the markup on custom options are inflated allowing the primary bid to be low. Each contractor will handle this differently.

When multiple vendors bid on each work function of the project with each contractor we can see there is a huge volume of duplicated work in that all the different vendors are doing the same takeoff in different ways to produce their bids. The cost for this work is absorbed by any eventual customer who pays for construction work whether it residential, remodel or commercial work. These same inefficiencies exist in any industry that has complex and multi-part products to offer for sale, thus requiring bidding by vendors.

### SUMMARY

In accordance with one embodiment:

We are describing the embodiment that applies to designing, preparing bidding documents, releasing to bid, receiving bids, awarding contracts, and monitoring billing. These activities as a whole could be described as “the purchasing process” although it is a broad description. The aspect that is being described is for a residential homebuilder building a house. It is not the intention to limit the scope of this invention, as it can be used in remodeling, commercial construction and/or any other product category which would benefit from a concise description of a multi-part product.

This embodiment is a process and method using a computer and the internet to manipulate what we will call “Design Cost Codes” (DCC). These DCC are the feature for describing and grouping activities relating to materials and/or labor, and converting them to standardized units. These units will allow for expedited design, conversion of incoming bids, and comparison of pricing data even when vendors varied estimating styles are used. The cost of these units can be altered by time, location, and commodity costs. This embodiment also allows for automated updating of contracts without rebidding.

### BRIEF DESCRIPTION OF DRAWINGS

Drawings, figures, and flowcharts as well as accompanying detailed descriptions illustrate several embodiments. These describe the changes in the functioning of the computer processors, the alteration in the data storage devices and the subsequent re-calibration of the input data resulting in new and self-updating tools for use in the purchasing of construction or other multi part products. It should be understood, however that drawings and descriptions are designed for the purpose of illustration only and not as a definition of the limits of the invention. Therefore:

FIG. 1. is Diagram of the hardware manipulation and internet based application

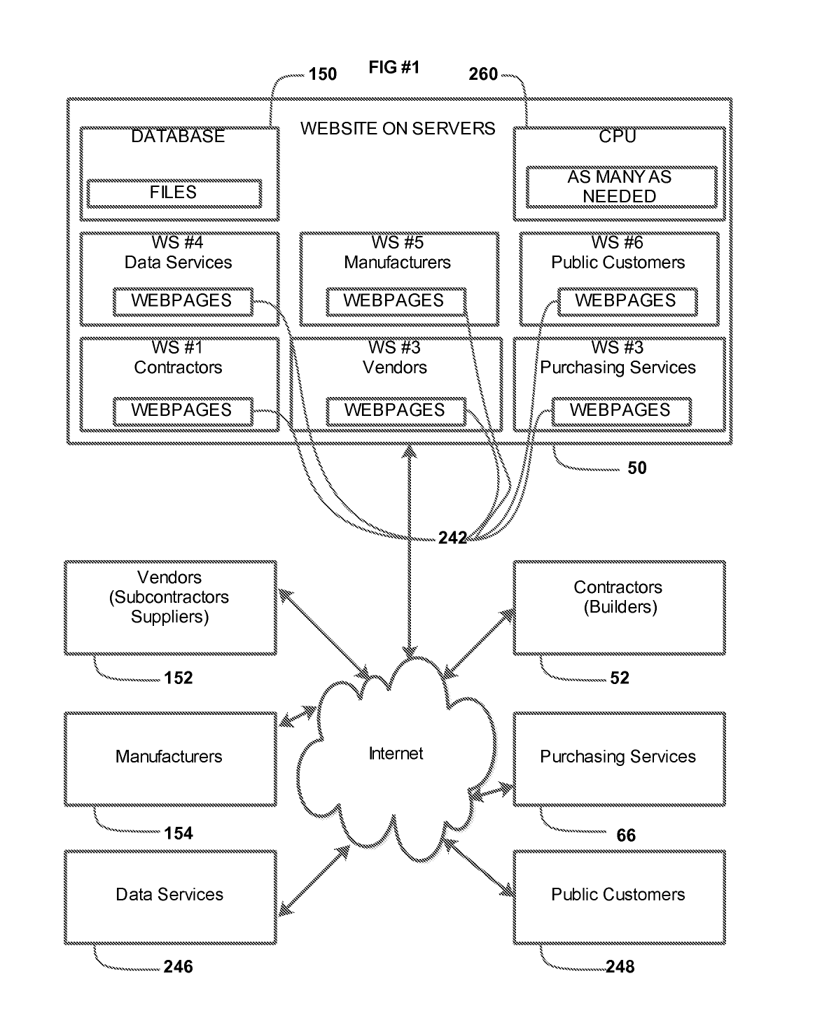

FIG. 2. is Basic process flowchart

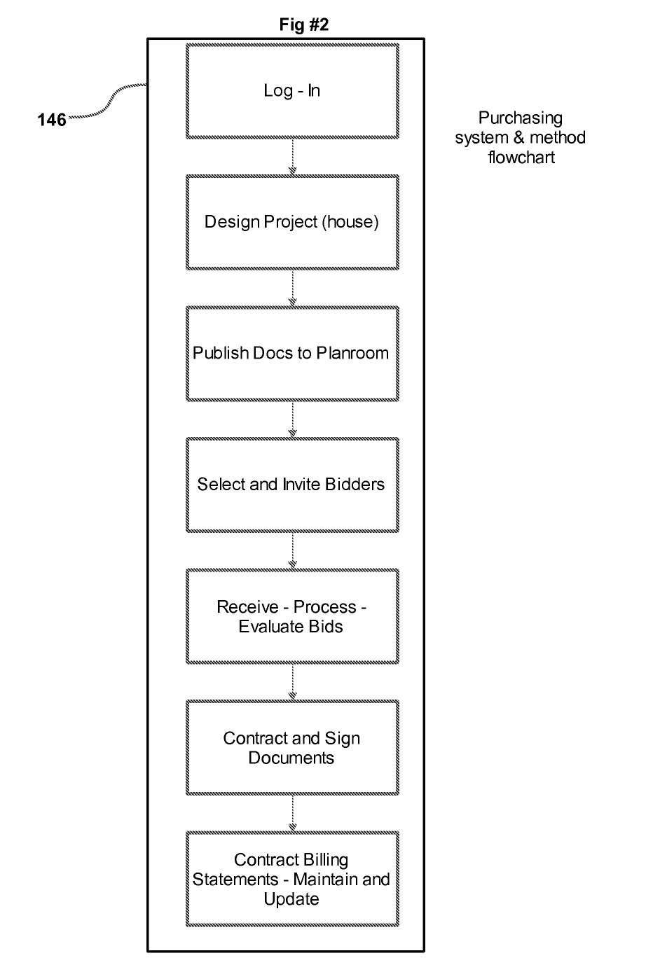

FIG. 3. is Standard login routine

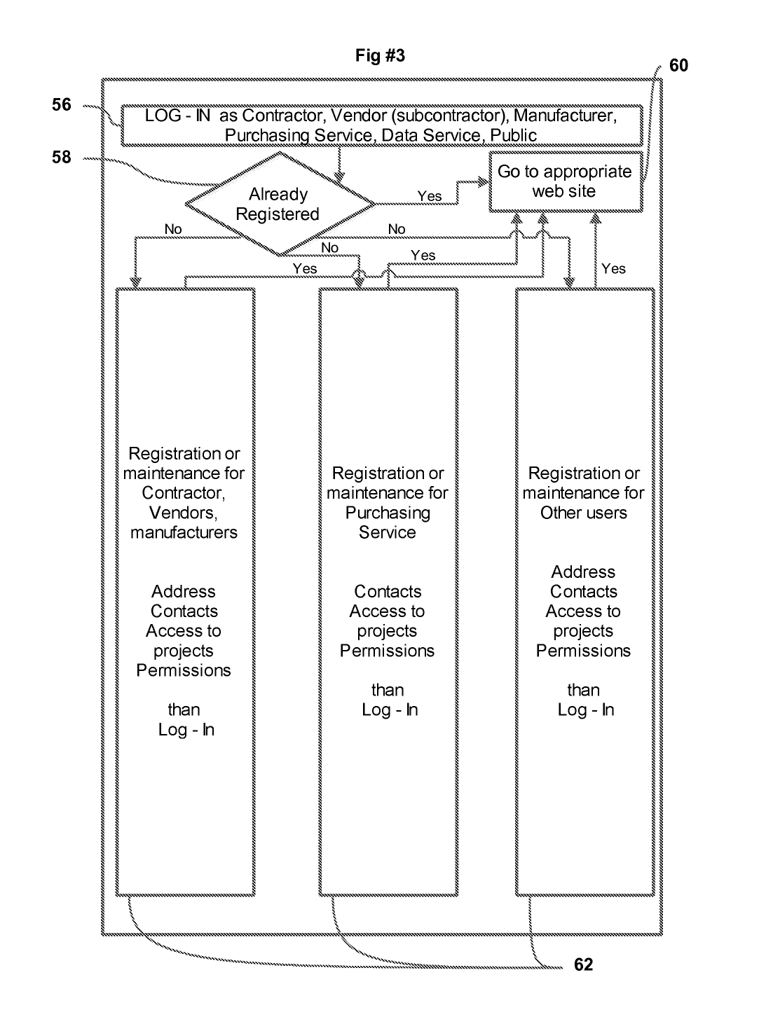

FIG. 4. is Contractor web site flowchart

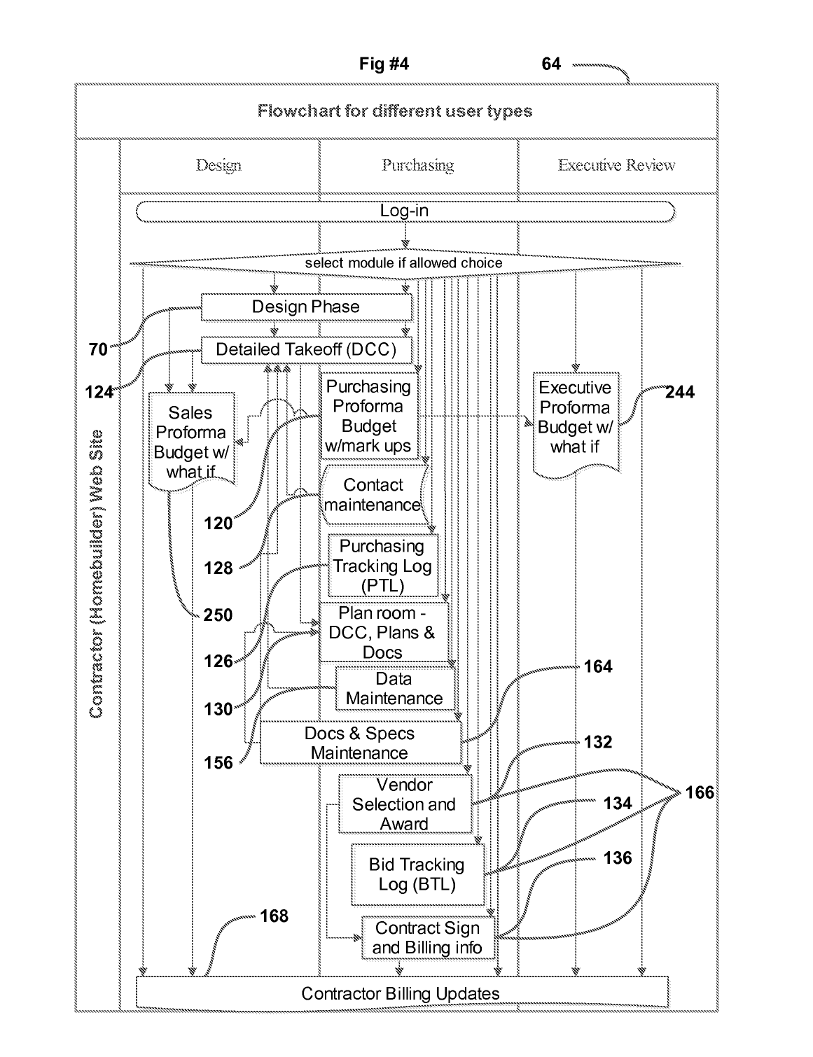

FIG. 5. is Vendor web site flowchart

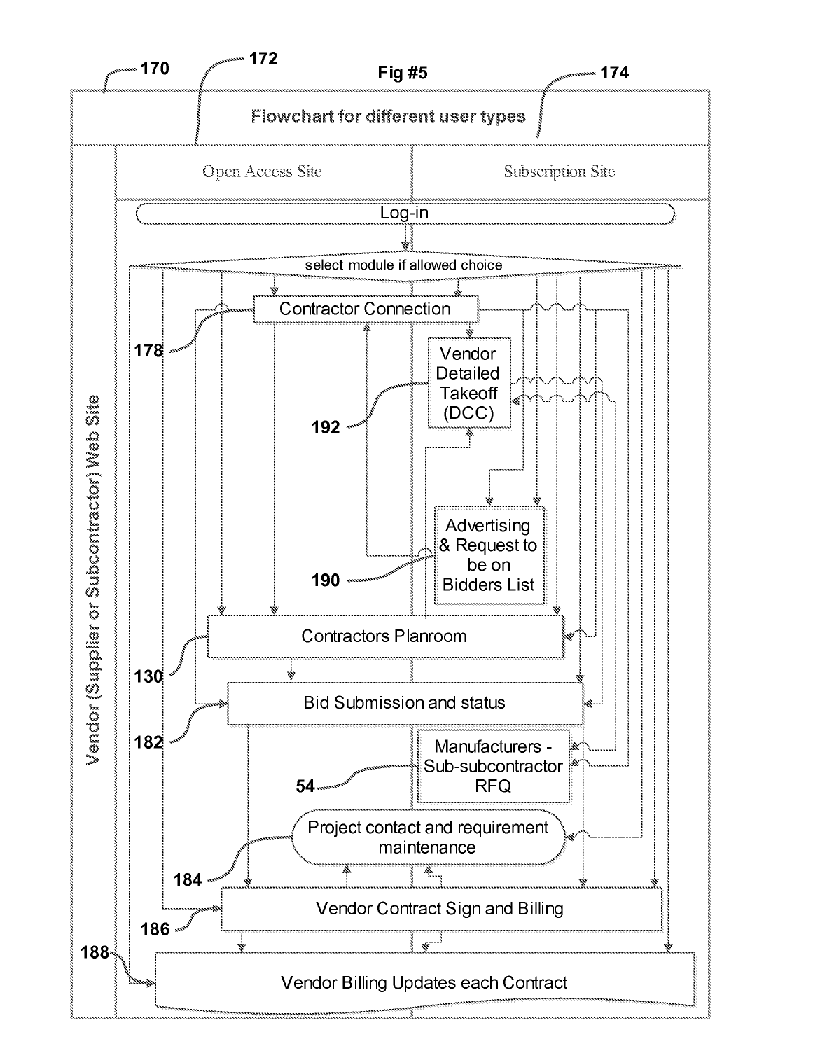

FIG. 6. is Purchasing Service web site flowchart

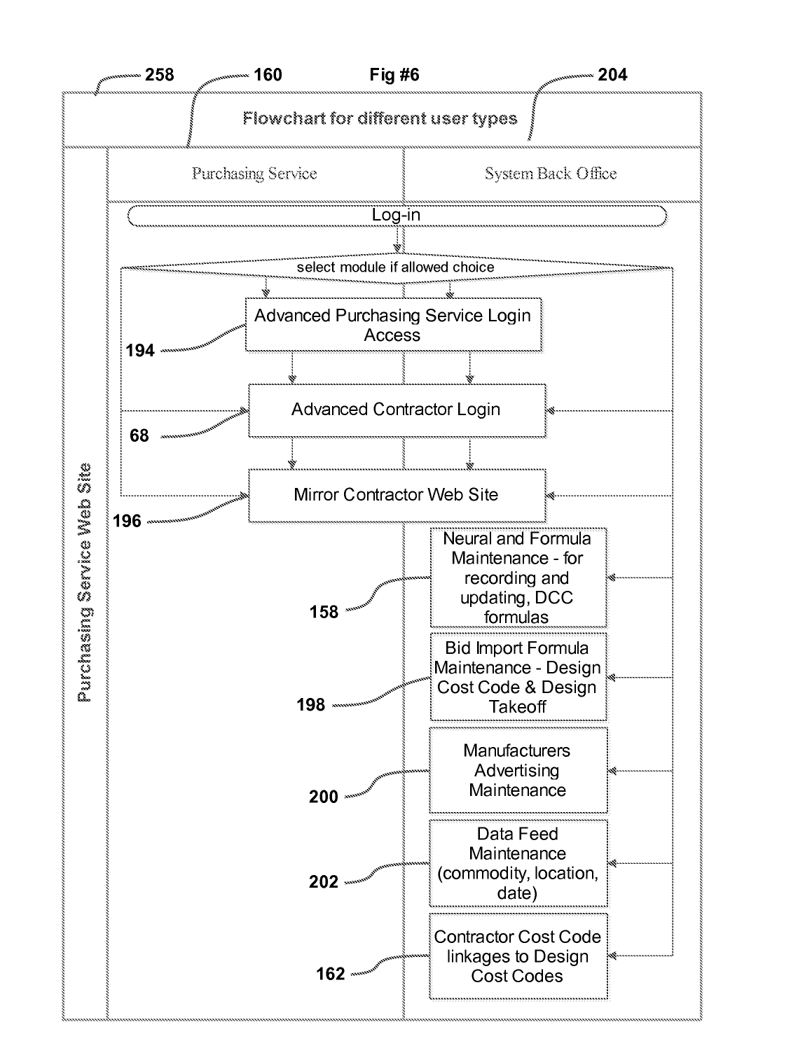

FIG. 7. is Manufacturer web site flowchart

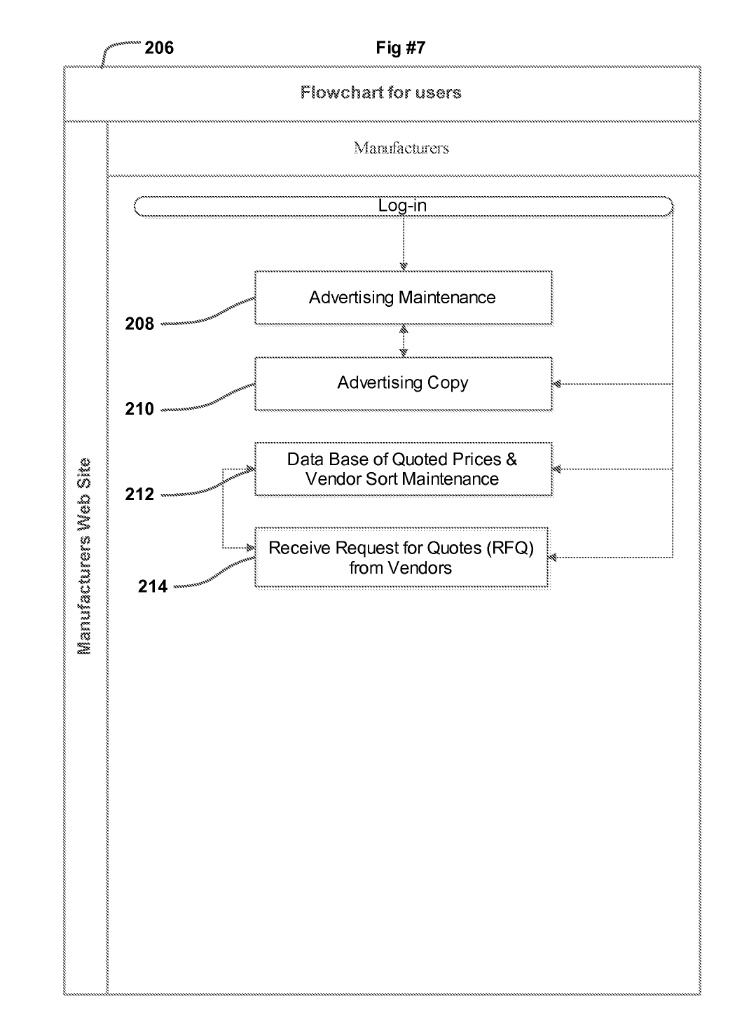

FIG. 8. is Data Service(s) web site flowchart

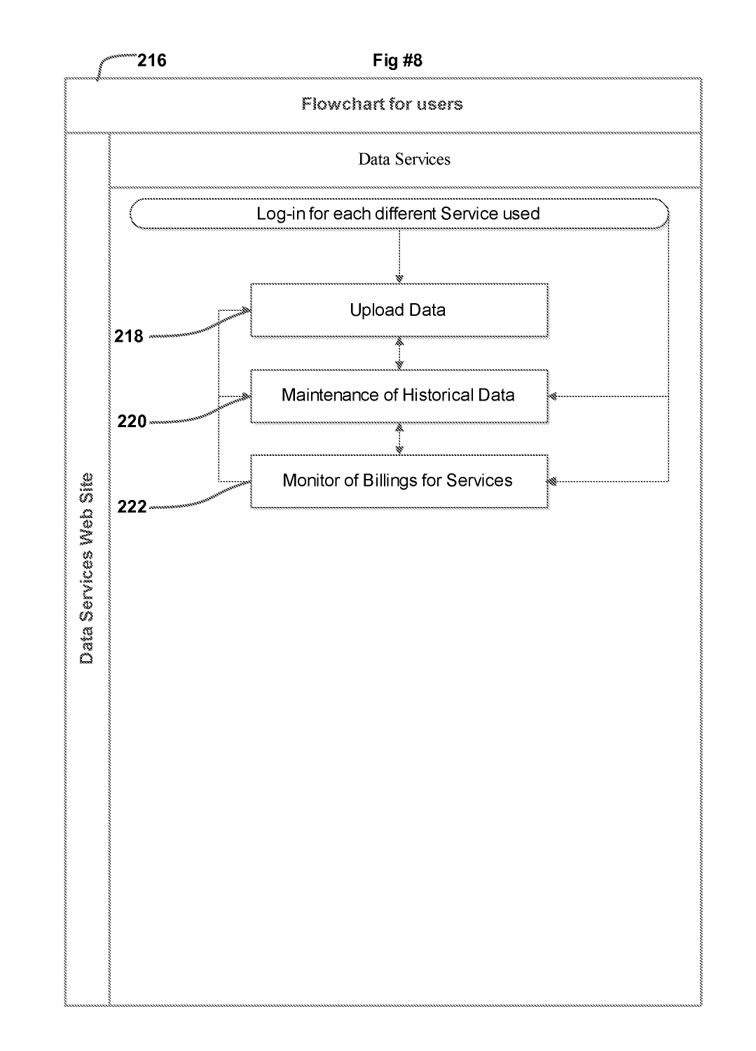

FIG. 9. is Public web site flowchart

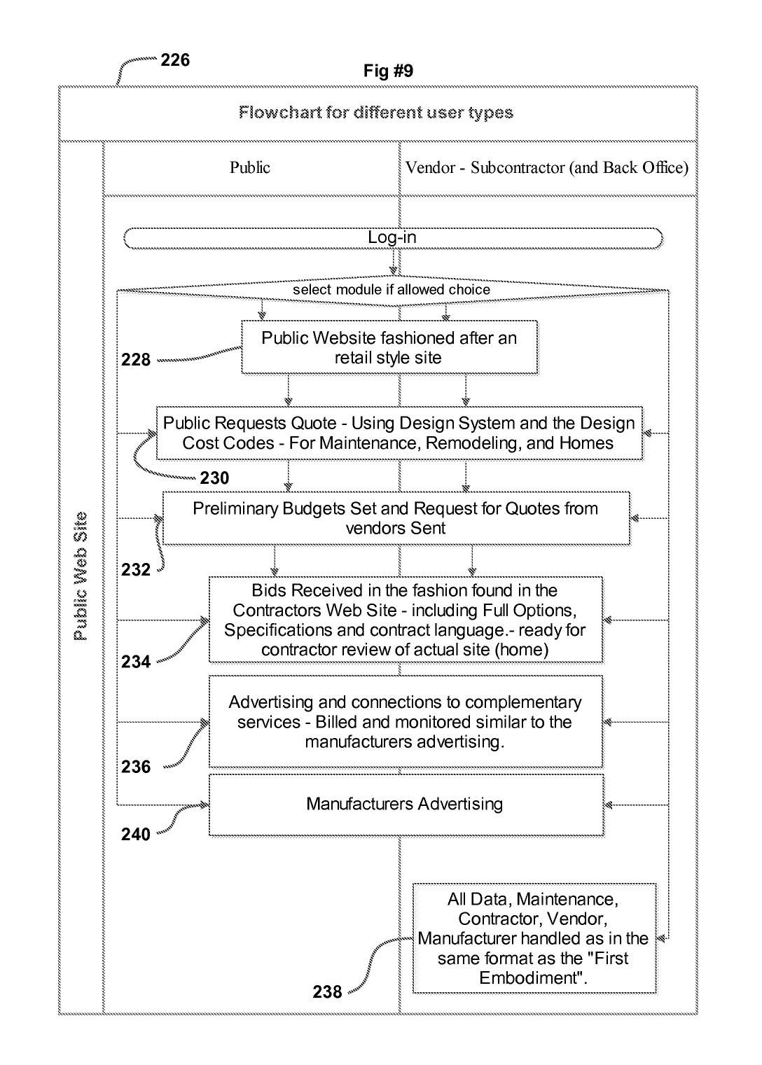

FIG. 10. is Basic program worksheet configuration

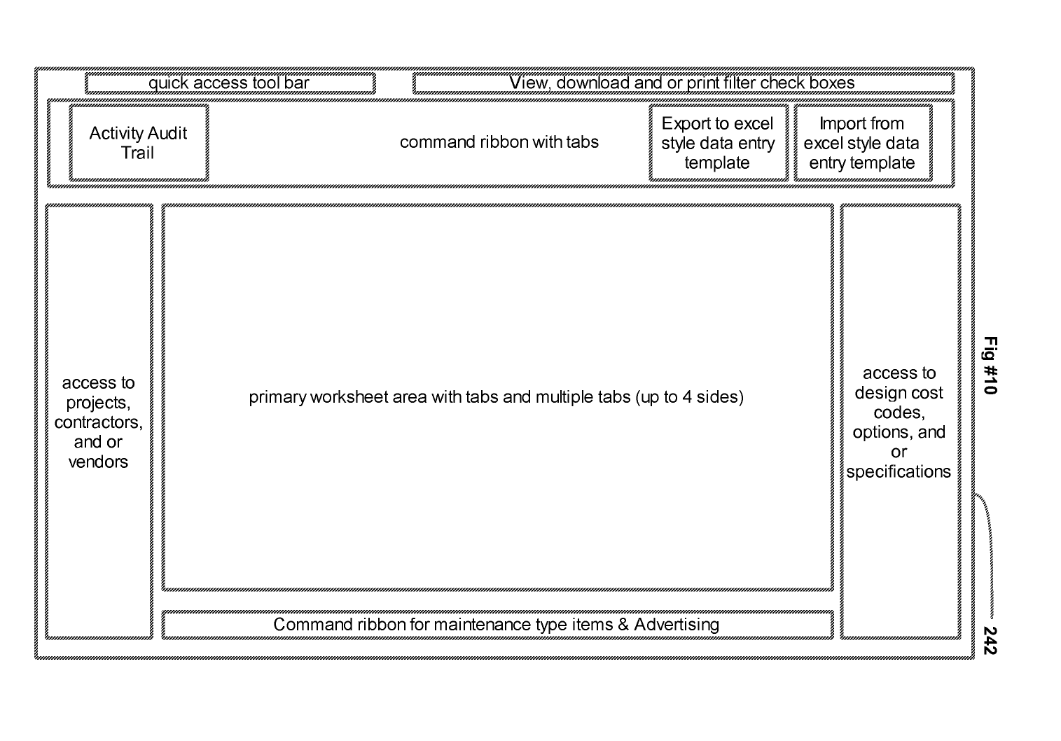

FIG. 20. is Sample contact information

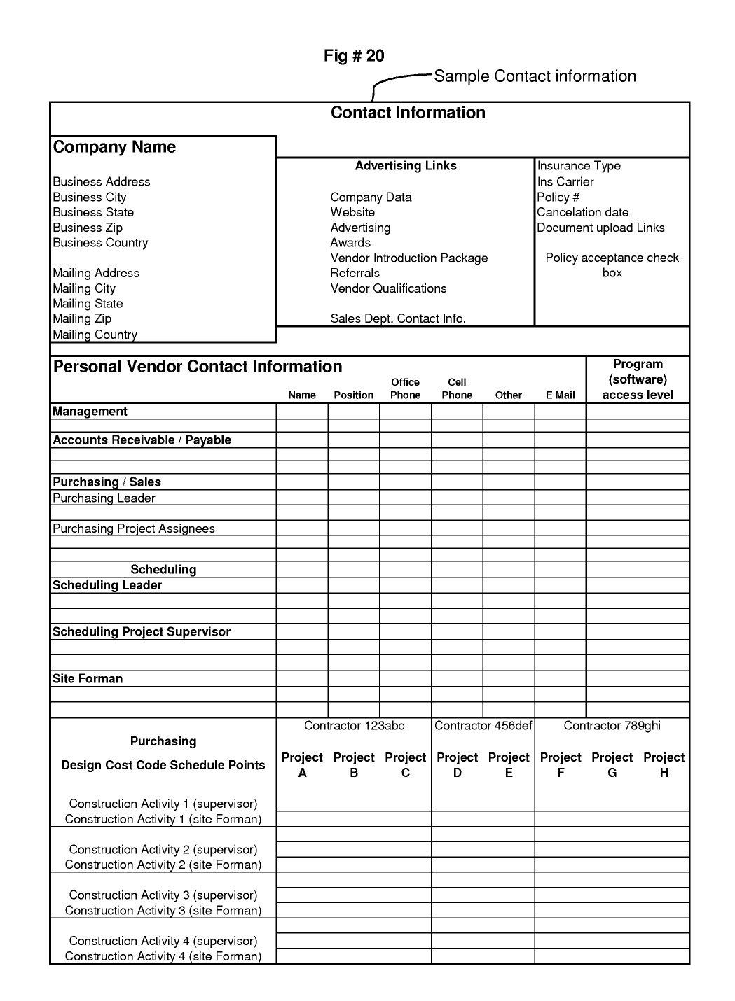

FIG. 21A is Sample design cost code list

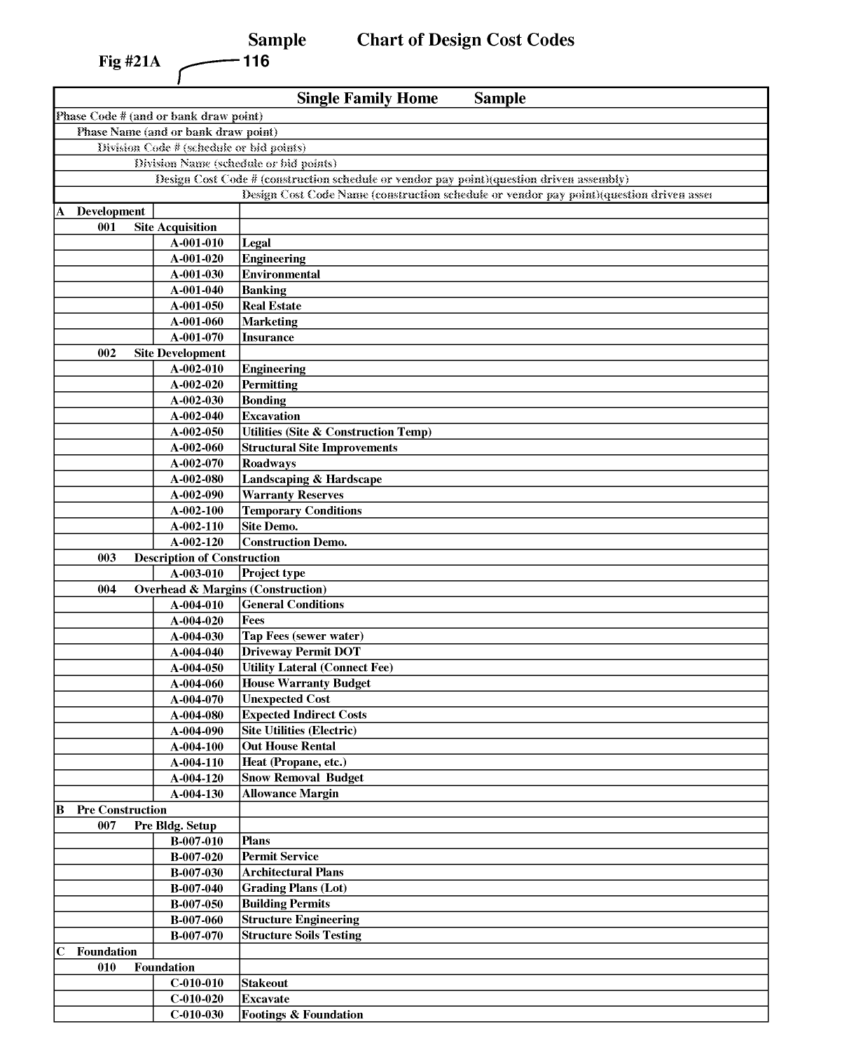

FIG. 22A is Sample room name layouts & options

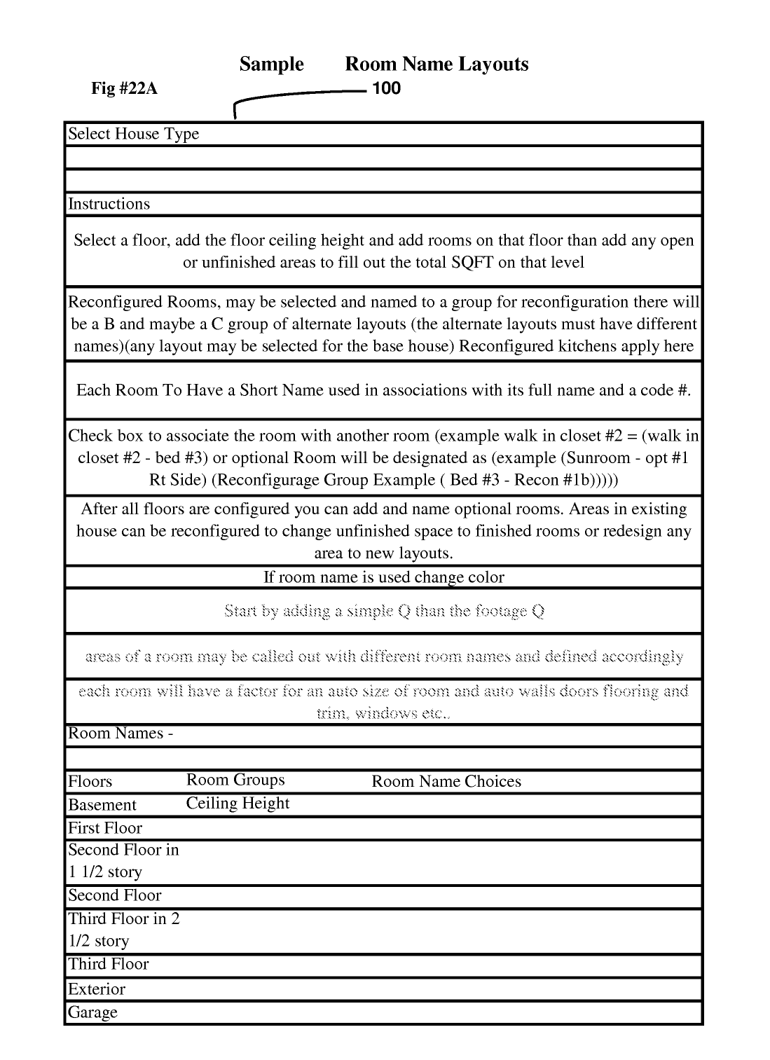

FIG. 22B is Sample room name layouts & options

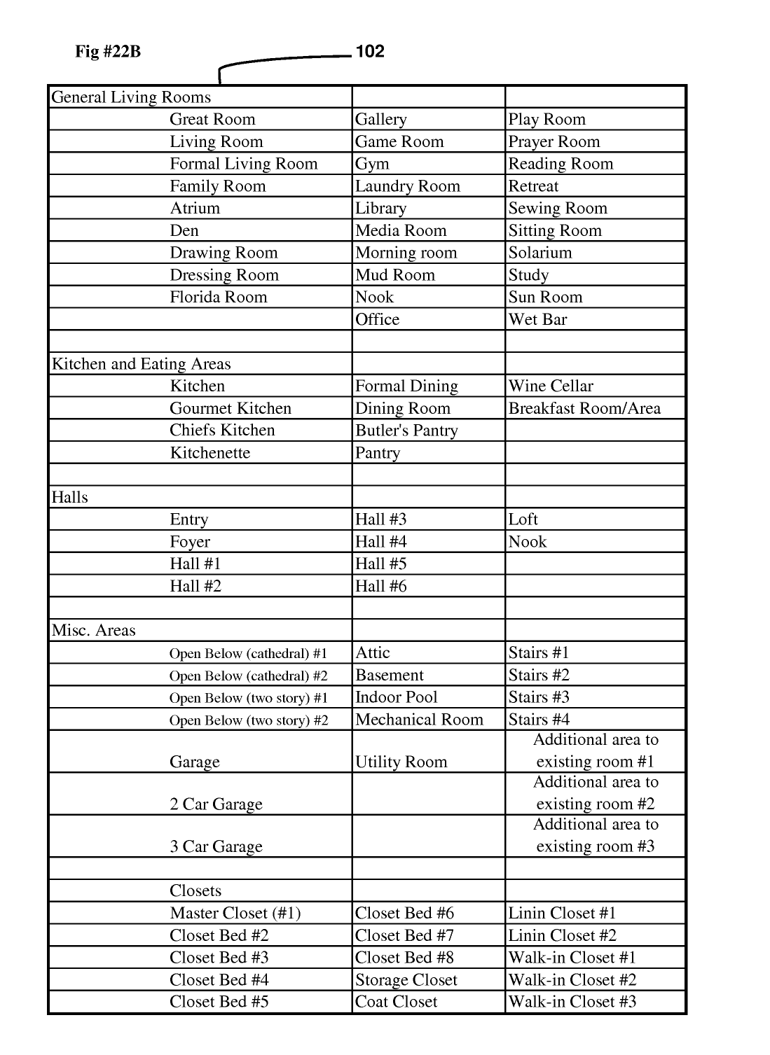

FIG. 22C is Sample room name layouts & options

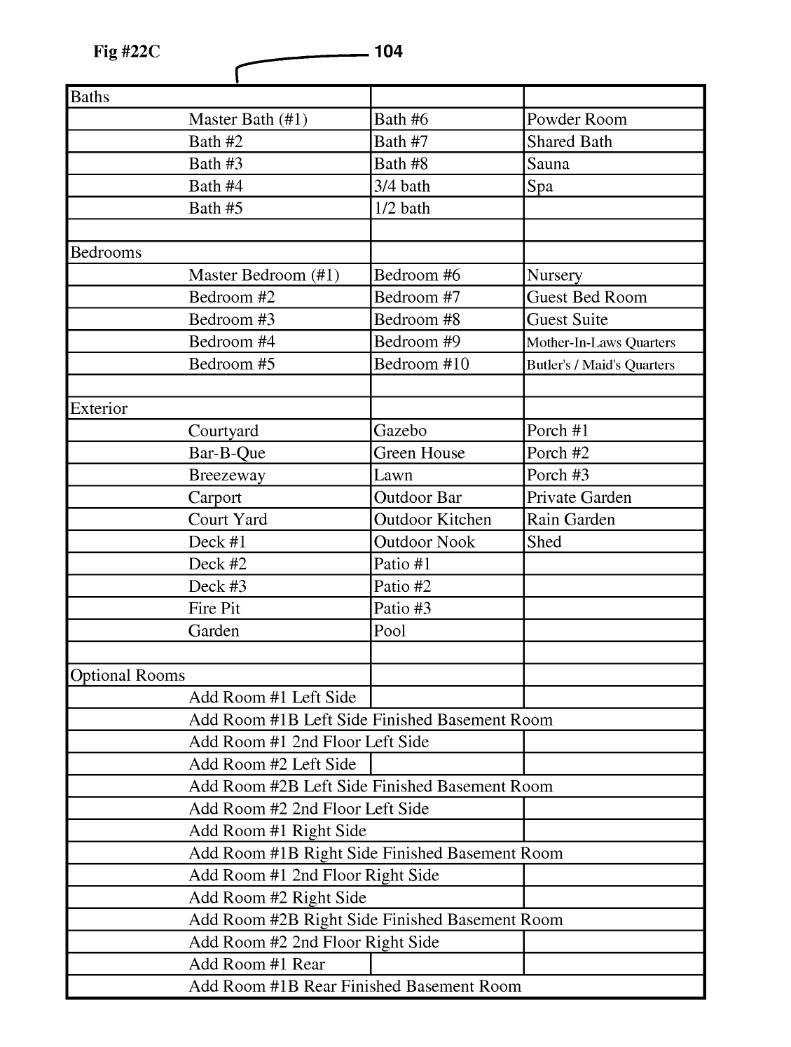

FIG. 22D is Sample room name layouts & options

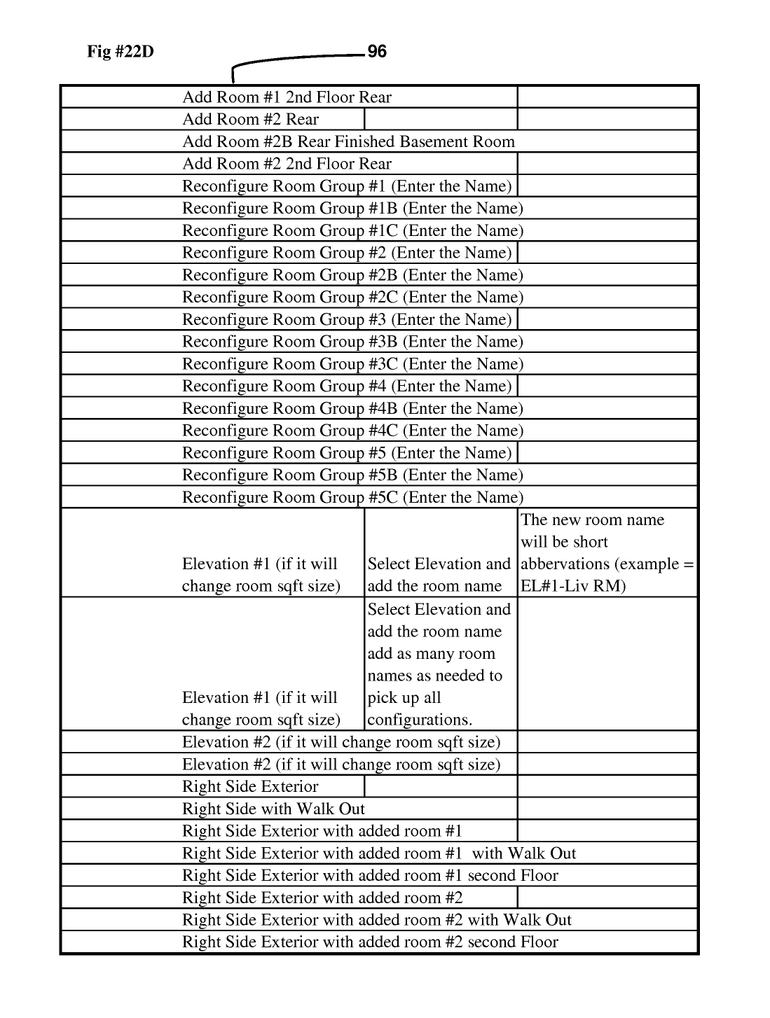

FIG. 22E is Sample room name layouts & options

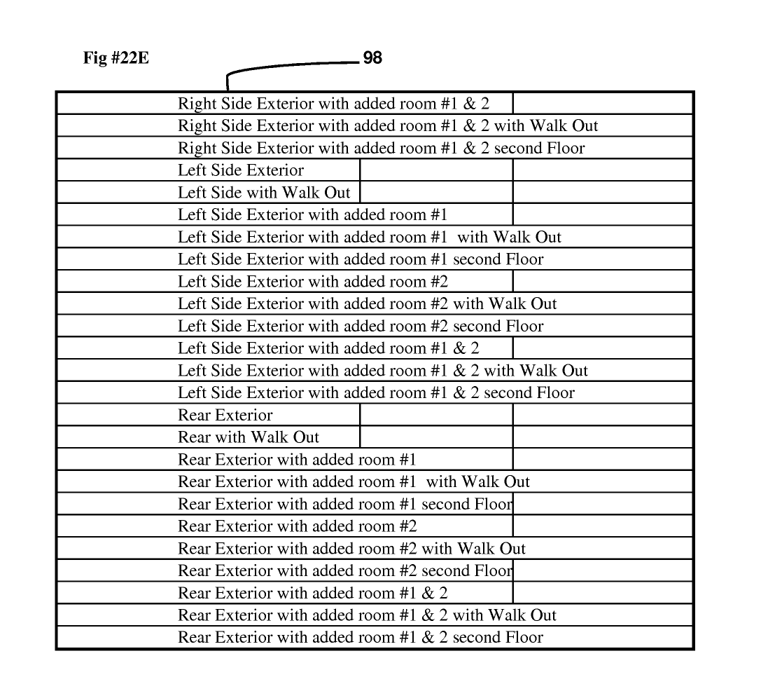

FIG. 23. is Sample options and some groups

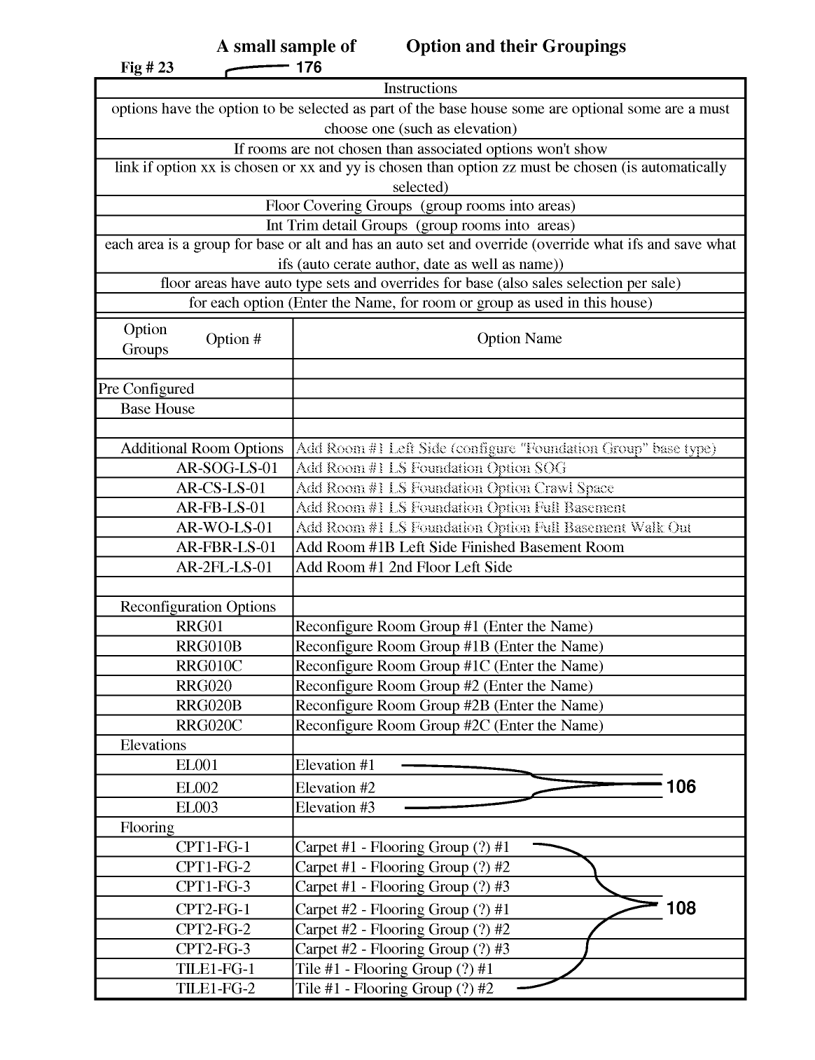

FIG. 24. is Sample of design cost codes takeoff items, vendors takeoff items

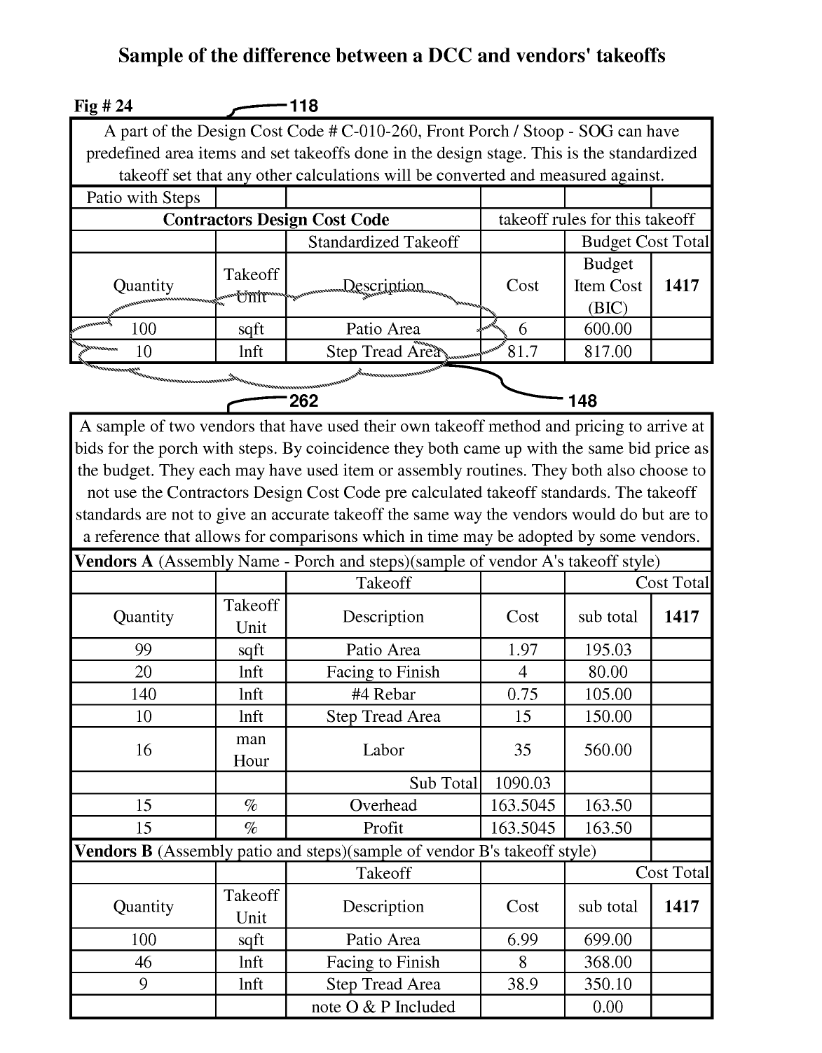

FIG. 25. is Sample bid sheet download information

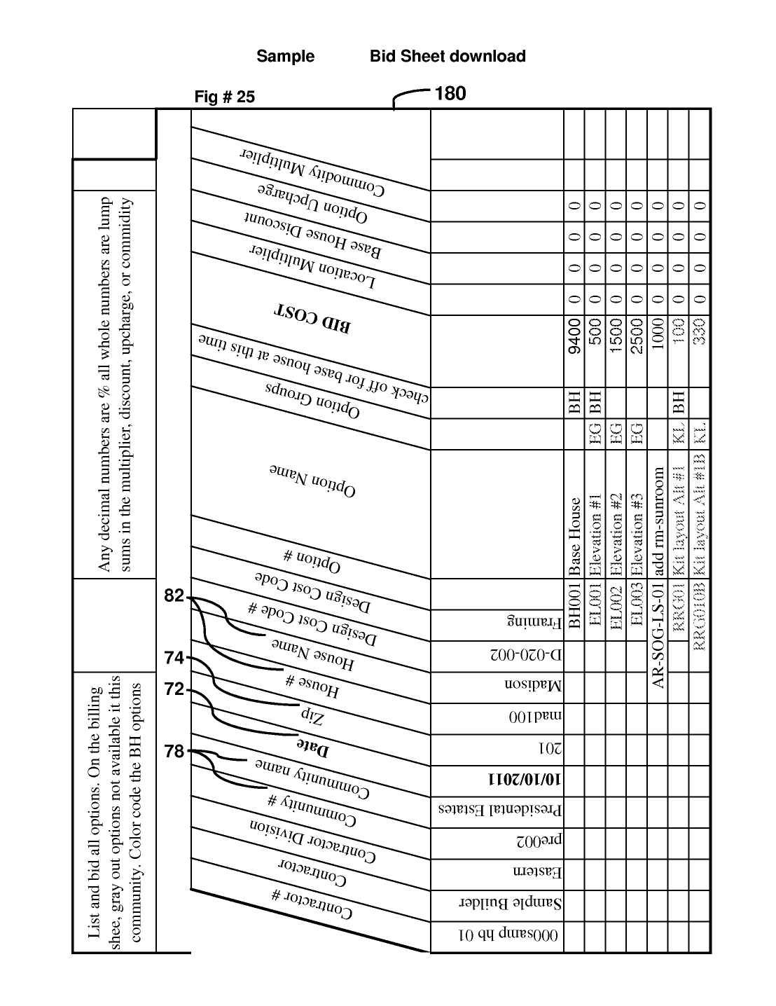

FIG. 26A. is Sample vendor bid with project billing

FIG. 26B. is Sample of billing changes to FIG. 26A

FIG. 27A is Sample design questions

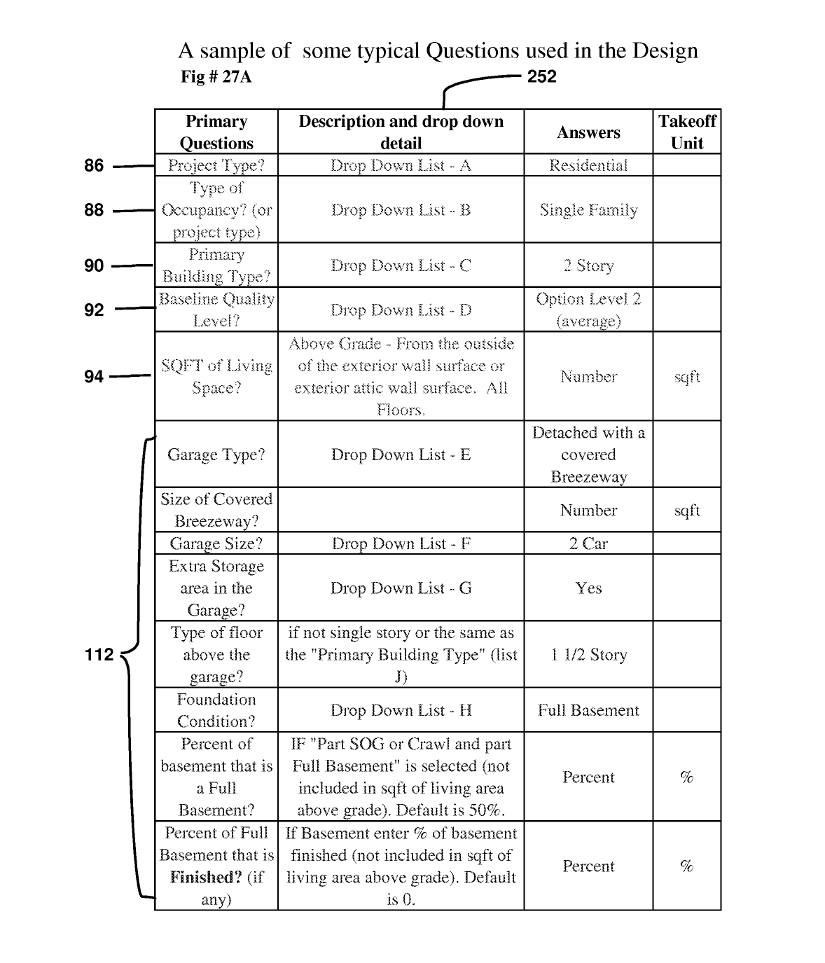

FIG. 27B is Sample design questions

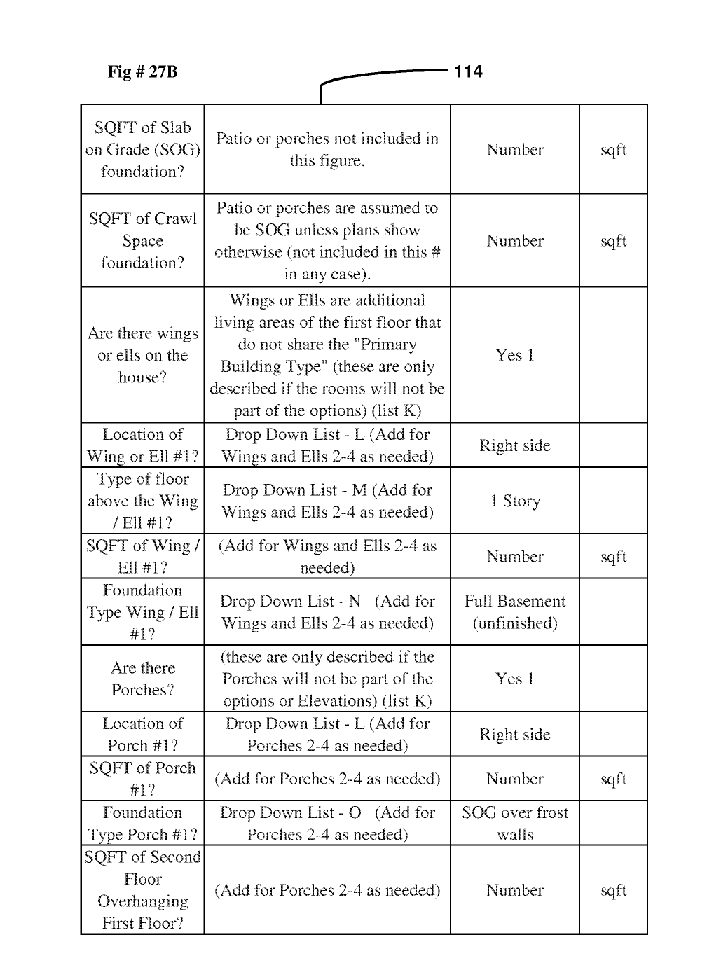

FIG. 27C is Sample design questions

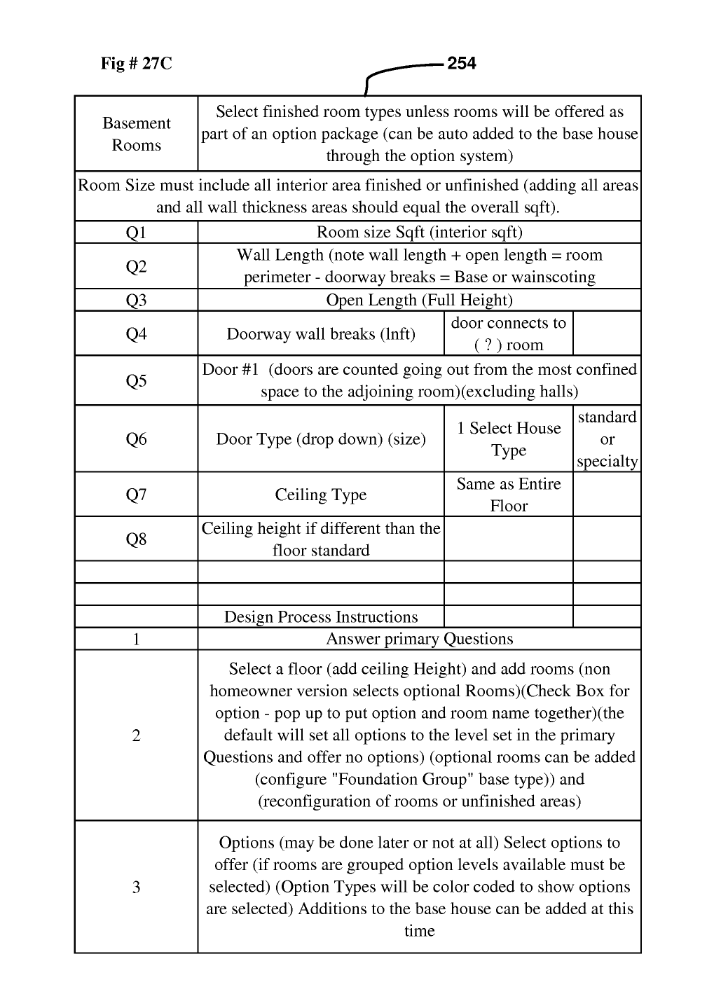

FIG. 28. is Sample design question dropdown box answers

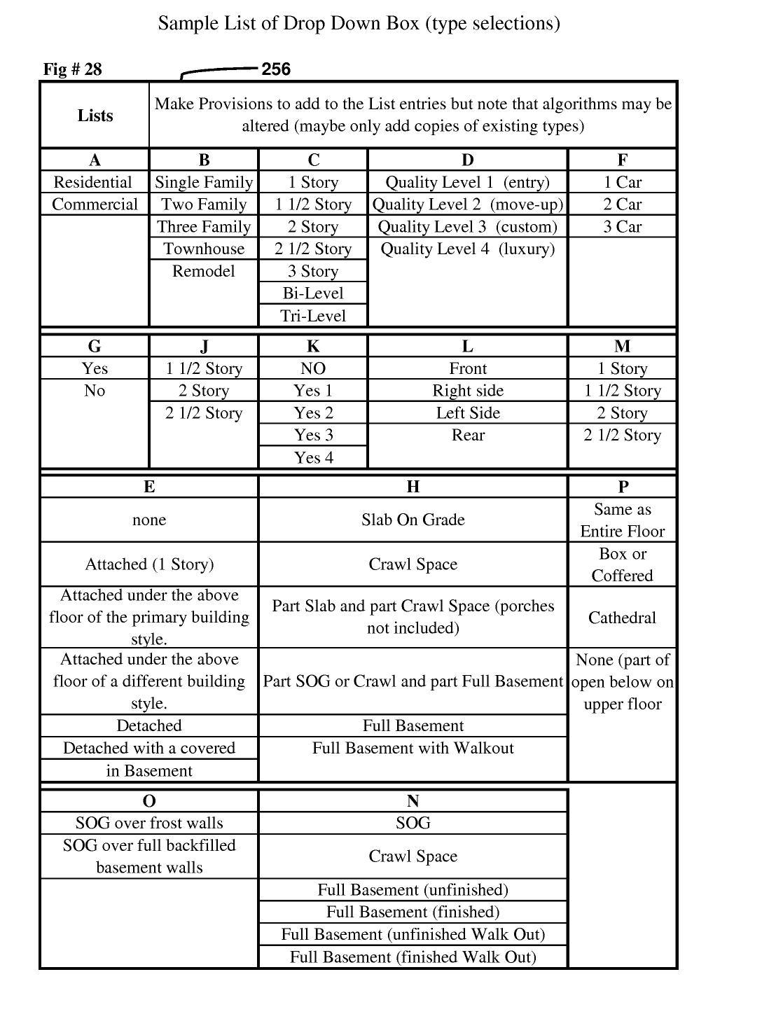

### DEFINITIONS

Contractor—shall be a general contractor as in describing a commercial building environment, a homebuilder providing multiple trade and material services whether they are custom builders or production homebuilders. Remodelers of commercial or residential projects participating in multiple aspects may also be called contractors. One of the modules available is for Contractors having a variety of features.

Vendor—shall be a material and/or labor provider whether viewing themselves as supplier or subcontractor, sub-subcontractor or any other designation. The Vendor has a module with a feature set that is open to any for the purpose of certain types of bid submissions. Additionally there is a module for Vendors with a greater feature set.

Manufacturer—shall be a supplier that generally provides material to vendors or contractors at the more detailed level and may wish to advertise their offerings as the system allows. Additionally the Vendor advanced module may request item quotes from manufacturers for items. If a manufacturer was to offer items for sale to the primary contractor it would then be considered a Vendor.

Purchasing Service—shall be an entity using the purchasing service module. This will function the same as the contractor module with the addition of routines to handle the merging of the disparate data from each subscribing company.

Data Services—shall be the companies that provide any form of information that is integrated into the system to manipulate the computations or operation. This may be information as to the cost variables in construction cost by region, time or other sources. Additionally the use of commodity pricing would be another type of information.

Public—shall be users of the services who act like designers in that they describe what they want and get pricing, then request bids. These services will be in an additional embodiment and use separate feature sets, although the underlying functioning of the public offering is the same as that for other users.

Assembly—An estimating “Assembly” is a collection of item costs and takeoff quantities manipulated by formulas to result in the cost of the assembly as a whole. The assembly functions by the collection of takeoff quantities gathered by some means such as direct takeoff, questions or Building Information Modeling (BIM). Then the quantities are added to the items that make up the assembly. These items may already exist or may be required to be selected as part of the assembly process. Each of these items has a unit cost associated with it; that cost is defined by the items' component parts such as labor, materials, subcontractor, equipment or other. The component parts of an item may have different unit costs than the item itself; when this happens a formula translates the unit cost of the component into the unit cost of the item. With the quantities added there is a cost value generated for the assembly as a whole, but also values can typically be expressed as the cost of each item in the assembly. Additionally, the values for the totals of the components of the items are available.

Cost Code—A “Cost Code” is used in construction to define a group of activities to limit the scope of work to like items that are performed by a single vendor. These codes are also used in various other ways, such as to group activities as to payment or scheduling items. Each contractor will have a variation on these items according to how they conduct their business.

Design Cost Code—A “Design Cost Code” (DCC) (a unique aspect of this system) is the feature used to collect the cost data from a vendor for a base house or an option for a specific construction material and/or service. The collection of costs for all house features (base house and options) and all houses that are in a community(s) for each design cost code that a vendor is bidding on is the basis for the payment schedule for that vendor. The use of the word Design in describing the DCC is because the DCC has additional functions. The DCC as described is acting as a receptacle for the collection of takeoff data that will be used to unitize the cost. The takeoff quantities in the DCC will be available for use by the takeoff assemblies beneath the DCC structure if the bidding vendor desires to use this feature of the software package. The other function of the DCC is to gather the individual vendors' lump sum bid prices, standardizing them and populate the DCC unitized items so that all vendors' bids are being examined in the same format. This makes possible many of the budgeting and contracting features.

Base House—A “Base House” is the term used to describe the house as offered without any changes. We also use the term base house to refer to any starting point to describe any project; commercial, remodel or other.

Option—The changes to a project are termed options, additions, deletions, variances or other such terms. We will use the term “Option” to describe any change to the base house.

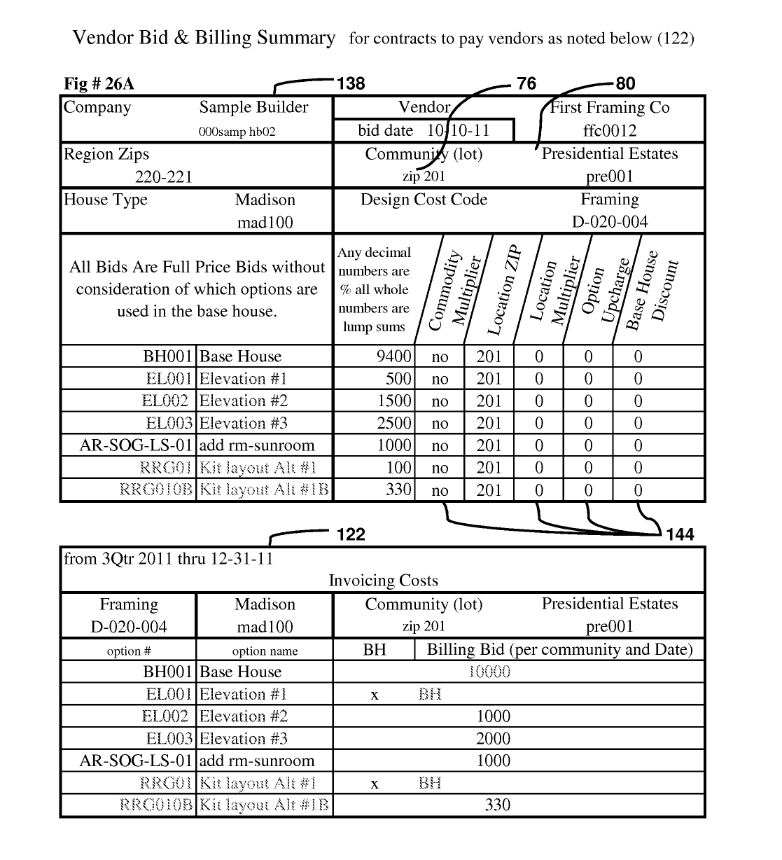

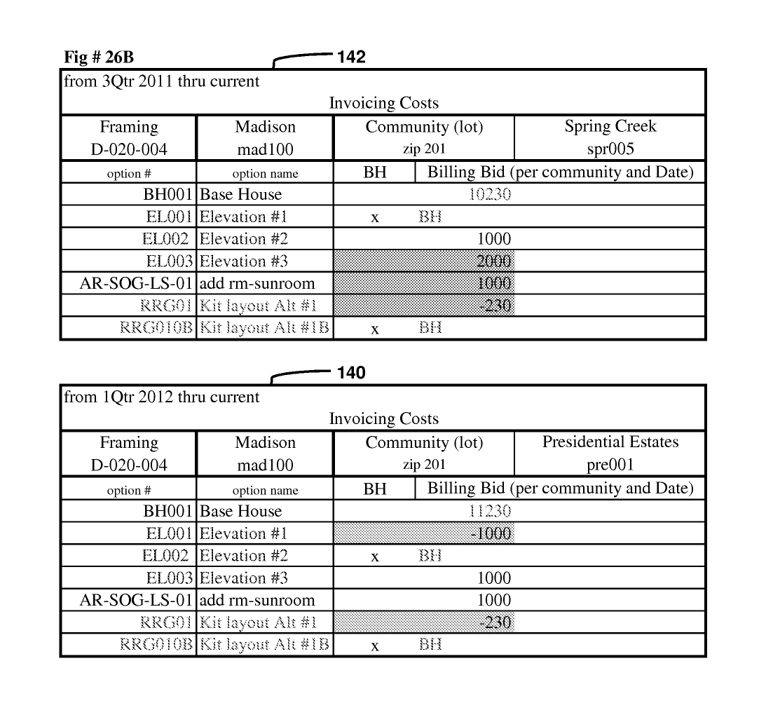

DRAWING-REFERENCE NUMBERS

| Part # | Part Name | FIG. # | FIG. Name |
|---|---|---|---|
| 50 | website on server | 1 | Diagram of the hardware manipulation |
| 52 | contractor | 1 | Diagram of the hardware manipulation |
| 54 | vendors RFQ to manufacture | 5 | Vendor web site flowchart |
| 56 | standard login | 3 | Basic login routine |
| 58 | registration decision | 3 | Basic login routine |
| 60 | to website program | 3 | Basic login routine |
| 62 | contact & registration | 3 | Basic login routine |
| 64 | contractors' flowchart | 4 | Contractor web site flowchart |
| 66 | Purchasing Service | 1 | Diagram of the hardware manipulation |
| 68 | contractor selection & data | 6 | Purchasing Service web site flowchart |
| 70 | design phase | 4 | Contractor web site flowchart |
| 72 | date of project | 25 | Sample bid sheet download information |
| 74 | zip (first 3 #) location | 25 | Sample bid sheet download information |
| 76 | zip (first 3 #) location | 26A | Sample vendor bid with project billing |
| 78 | location # & name | 25 | Sample bid sheet download information |
| 80 | location # & name | 26A | Sample vendor bid with project billing |
| 82 | project # & name | 25 | Sample bid sheet download information |
| 84 | project # & name | 26A | Sample vendor bid with project billing |
| 86 | project type | 27A | Sample design questions |
| 88 | project type of occupancy | 27A | Sample design questions |
| 90 | building type | 27A | Sample design questions |
| 92 | quality demographic | 27A | Sample design questions |
| 94 | size | 27A | Sample design questions |
| 96 | structural areas | 22D | Sample room name layouts & options |
| 98 | structural areas | 22E | Sample room name layouts & options |
| 100 | room & option names | 22A | Sample room name layouts & options |
| 102 | room & option names | 22B | Sample room name layouts & options |
| 104 | room & option names | 22C | Sample room name layouts & options |
| 106 | structural option sample | 23 | Sample options and some groups |
| 108 | grouped option sample | 23 | Sample options and some groups |
| 110 | contact data different levels | 20 | Sample contact information |
| 112 | room defining questions | 27A | Sample design questions |
| 114 | room defining questions | 27B | Sample design questions |
| 116 | design cost codes | 21A | Sample design cost code list |
| 118 | simple DCC takeoff data | 24 | Sample of DCC vs. vendors' takeoff compared |
| 120 | purchasing budget review | 4 | Contractor web site flowchart |
| 122 | project specific billing | 26A | Sample vendor bid with project billing |
| 124 | detailed takeoff area | 4 | Contractor web site flowchart |
| 126 | purchasing tracking log | 4 | Contractor web site flowchart |
| 128 | internal contacts | 4 | Contractor web site flowchart |
| 130 | planroom | 4&5 | contractor & vendor websites |
| 132 | external contacts | 4 | Contractor web site flowchart |
| 134 | bid tracking log | 4 | Contractor web site flowchart |
| 136 | contractor contract signing | 4 | Contractor web site flowchart |
| 138 | winning bid data & billing | 26A | Sample vendor bid with project billing |
| 140 | reconfigured existing contract | 26B | Sample of billing changes to FIG. 26A |
| 142 | new contract same house type | 26B | Sample of billing changes to FIG. 26A |
| 144 | pricing deviations | 26A | Sample vendor bid with project billing |
| 146 | purchasing system & method | 2 | Basic process flowchart |
| 148 | DCC item breakdown | 24 | Sample of DCC vs. vendors takeoff compared |
| 150 | data storage (databases) | 1 | Diagram of the hardware manipulation |
| 152 | vendor | 1 | Diagram of the hardware manipulation |
| 154 | manufacturer | 1 | Diagram of the hardware manipulation |
| 156 | data maintenance | 4 | Contractor web site flowchart |
| 158 | formula maintenance | 6 | Purchasing Service web site flowchart |
| 160 | purchasing services | 6 | Purchasing Service web site flowchart |
| 162 | data (cost codes to DCC) | 6 | Purchasing Service web site flowchart |
| 164 | contract, scope, & specs. data | 4 | Contractor web site flowchart |
| 166 | bidding process | 4 | Contractor web site flowchart |
| 168 | contractor billing data (AP) | 4 | Contractor web site flowchart |
| 170 | vendors' flowchart | 5 | Vendor web site flowchart |
| 172 | vendor open access | 5 | Vendor web site flowchart |
| 174 | vendor subscription site | 5 | Vendor web site flowchart |
| 176 | options | 23 | Sample options and some groups |
| 178 | vendors contractor connection | 5 | Vendor web site flowchart |
| 180 | bid sheet | 25 | Sample bid sheet download information |
| 182 | bid submission and return | 5 | Vendor web site flowchart |
| 184 | contact maintenance | 5 | Vendor web site flowchart |
| 186 | vendor contract signing | 5 | Vendor web site flowchart |
| 188 | vendor billing data (AR) | 5 | Vendor web site flowchart |
| 190 | advertising to others | 5 | Vendor web site flowchart |
| 192 | detailed takeoff area | 5 | Vendor web site flowchart |
| 194 | advanced login system | 6 | Purchasing Service web site flowchart |
| 196 | mirror of contractors site | 6 | Purchasing Service web site flowchart |
| 198 | import formula maintenance | 6 | Purchasing Service web site flowchart |
| 200 | advertising maintenance | 6 | Purchasing Service web site flowchart |
| 202 | data feed maintenance | 6 | Purchasing Service web site flowchart |
| 204 | back office | 6 | Purchasing Service web site flowchart |
| 206 | manufactures flowchart | 7 | Manufacturer web site flowchart |
| 208 | advertising maintenance | 7 | Manufacturer web site flowchart |
| 210 | advertising copy | 7 | Manufacturer web site flowchart |
| 212 | send & receive quotes | 7 | Manufacturer web site flowchart |
| 214 | takeoff area | 7 | Manufacturer web site flowchart |
| 216 | data service flowchart | 8 | Data Service(s) web site flowchart |
| 218 | upload data | 8 | Data Service(s) web site flowchart |
| 220 | historical data | 8 | Data Service(s) web site flowchart |
| 222 | monitor billing | 8 | Data Service(s) web site flowchart |
| 224 | data & license maintenance | 8 | Data Service(s) web site flowchart |
| 226 | public flowchart | 9 | Public web site flowchart |
| 228 | public website style | 9 | Public web site flowchart |
| 230 | simplified takeoff questions | 9 | Public web site flowchart |
| 232 | budget review and RFQ | 9 | Public web site flowchart |
| 234 | contract, scope, & specs. data | 9 | Public web site flowchart |
| 236 | contractor & vendor info | 9 | Public web site flowchart |
| 238 | vendor access & back office | 9 | Public web site flowchart |
| 240 | manufactures advertising | 9 | Public web site flowchart |
| 242 | worksheet layout | 1&10 | |
| 244 | executive budget review | 4 | Contractor web site flowchart |
| 246 | data services' | 1 | Diagram of the hardware manipulation |
| 248 | public users | 1 | Diagram of the hardware manipulation |
| 250 | sales budget review & markup | 4 | Contractor web site flowchart |
| 252 | question types | 27A | Sample design questions |
| 254 | takeoff questions and amounts | 27C | Sample design questions |
| 256 | takeoff questions and amounts | 28 | Sample design question dropdown answers |
| 258 | purchasing service flowchart | 6 | Purchasing Service web site flowchart |
| 260 | computer processors | 1 | Diagram of the hardware manipulation |
| 262 | vendor takeoff examples | 24 | Sample of DCC vs. vendors takeoff compared |

### DETAILED DESCRIPTION—ONE EMBODIMENT

The following is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

Although the present invention can be used in virtually any bidding situation where there is a need for buyers (contractors, public users), and sellers (vendors, contractors) (suppliers and/or sub-contractors), and the sales and purchasing departments of the respective companies or individuals. We will describe the process 260 from the viewpoint of each different user as they interact with each aspect of the system. The system and method of the present embodiment, however, could easily be converted into use in any other industry where there is a need for uniformity, standardization and the other efficiencies of this system.

An embodiment of the system and method 146 is for the purchasing department of a contractor (homebuilder) that offers homes for sale with a variety of options. The other participants in this system are the vendors (but could be other contractors if choosing to bid on all “Design Cost Codes”) that will bid on the parts of the house for which they offer goods and/or services. Also manufacturers are able to advertise and price products for vendors using this system. Data providers can also provide data that alters the formulas in the system, which can update pricing and other information as defined. Another module of the product offers an outsourced purchasing service for construction companies (homebuilders) or other product companies.

The website on a server 50 is accessed over the internet. The Contractor's 52 design department logs in and if the login 56 personnel are already registered 58 they can access their web site 60. If unregistered, then a registration 62,110 must take place. The contractor module 64 is selected and opened.

Contractor 52

Starting in the website 242 of the Contractor's Design Module select design phase 70 and begin the design phase

Design Phase 70

Select or define a project 252, add a project date 72, location (area code (last 3 digits) 74, and a community and/or lot) 78,80. Name the project with a number and name 82,84. Choose primary type 86,88, type of occupancy 88, building type 90, quality level (demographic) 92, primary size 94, size per level, additional fixed project areas 96, and define rooms 100,102,104.

Secondary design—select structural options 106, define and name structural options 96,102, select non-structural options 108, alter names of non-structural options as needed, confirm the grouping of options 108, confirm the “Design Cost Codes” (DCC) 116, assigned to options 176, and select the options that will be used as the base house offerings (at this time).

Third, the takeoff process 254 starts with detailed room definitions 112,114, detailed exterior descriptions 256. Than step through each DCC 116 for area takeoffs. This will create “Design Cost Code standardized takeoffs” 118 which will provide basic takeoff units which may be used by vendors. The detailed takeoff 124 will also provide detailed budget information based on the current database 150. The database is being refined and updated with each data set coming into the system.

Review the associated advertising descriptions and sales contract descriptions 164 associated with each option.

Configure the pro-forma budget 120 and markups 250, set the costs and have the budget locked and confirmed by management.

Review and use the Contractor billings 122 and any updates as needed.

Set margins for options and review sales budgets 250.

Purchasing Phase

As viewed from the standpoint of a purchasing employee working for a contractor. Following the process as outlined in the checklist known as the “Purchasing Tracking Log” (PTL) 126, the purchasing will be executed as follows:

Purchasing Tracking Log

When activities are completed the completion date and last logged in user will be recorded. If supervisory approval is needed this will override the completed-by notation. As is always the case the “activity audit trail” can be referenced to note users' activities. 1—Receipt of a Request. A request is received in any prescribed fashion and may include due dates for any part of the process, as well as any extra bidding instructions that are needed (including a link to a copy of the request form). 2—Confirm the accuracy of the contact list for the progress of this bid 128. 3—Send confirmation of the “Request for Quote” (RFQ) for this project. (This will include the link to the PTL of this project) (this can be automated.) 4—Confirm project details. Confirm that the plans and specifications are in place in the planroom 130, confirm the option sets and “Design Cost Code” (DCC) 124 are complete. Review the bidders 132 confirm that each DCC has been assigned to the invited bidders. Confirm that each bidder has a contact person. 5—Release the project to the bidders. 6—Release to bid notification sent. (This is an auto notification to all, necessary parties) 7—Contact vendors. Call the vendor contacts and confirm receipt of the requests for quotes, noting information on the “bid tracking log” (BTL) 134. Set up auto reminders for vendors. 8—Confirmation calls. Make calls to vendors that have not accessed the documents in the planroom. Record progress in BTL 134. 9—Confirmation calls. At the 50% time frame confirm if any invited bidders will decline to bid. 10—Contact the contractor. Call the contractor to inquire if more bidders are needed for the DCC. On the bid completion date auto shutdown of the planroom and bid uploads occurs and auto bid report is submitted. 11—Post-bid contact of the contractor. Confirm contracting status with the contractor regarding any necessary rebidding. 12—Re-Bid. Restart bidding as per instructions (DCC or vendors to re-bid). 13—Bid conclusion. Upon receipt of all re-bidding activity, send a bid conclusion notice to the contractor so winning bidders can be selected. 14—Winning bidders 132 selected. Contractor selects the winning bidders for all DCC. The “winning bidders conformation form” is then completed. 15—Release to contract. Receive the release to contract notice from the contractor. 16—Insurance. Confirm that winning bidders are current on their certificates of insurance. 17—Notify bidders. Send rejection and winning bid notices. 18—Planroom access. Release the access to the project planroom to the winning vendors. (Auto sent with the winning notice). 19—Contract signing. Contact vendors as needed to confirm that their contracts are signed 136. Lock to read only-status and change each contract to contracted status. Changing to contracted status will reset the budget to the actual budget. This will cause the color code to show its status. 20—Signing contracts complete. When entire project is contracted send contracted conclusion notice to the contractor.

Executive Review Phase

The “executive review module” 244 is available for a more detailed look at the pro-forma budget and the details of other similar activity on a regional or national basis. These reviews are adjusted by the cross comparison of the products offered nationwide that can be viewed by national data variances or internal company data.

Features to note in the application:

In the “design phase” there is a routine for grouping of options that are interrelated. These options would interact with each other in such a way that if one is chosen the others in the group can't be selected. An example would be if Elevation #1 122 is chosen in the base house then the options for elevations #2 thru #10 could not be selected at the same time. All options will always be required to be bid as the whole price 138 for the option. There will be a costing item for each option that allows for discounts to the option price when it is part of the base house. There will be a costing item for each option that allows for mark-ups to the option price it is not part of the base house and in the same group. Using this protocol will allow for contracts that reflect the base house pricing with the differentials for related options. When in the future, a different option in the group is selected as the base house option the other options in the group will automatically become re-priced 122,140, and the new billing structure will be reflected in the contractor billing updates 168,188 (and be propagated to the appropriate houses). An example of this would be if after a time, the sales department felt compelled to change the base house offerings 122,140. This also allows for contracting a house for one community and reconfiguring the house for a different customer demographic in the next community 142 without re-bidding. This will eliminate the re-bidding now required under other bidding systems.

In the “Design Phase” there is a routine for takeoff of the size, shape, and areas of the house. These takeoffs are analyzed and used in the formation of the “Contractors Design Cost Code Standardized Takeoff” (CDCCST) 118. The CDCCST information is available in the planroom for the vendors, according to their DCC access. The CDCCST information is the basis for the most detailed 124 and accurate form of the pro-forma budget. As a vendor's bid is received, any outlying costs are removed 144 the clean cost information noted and separated according to location, date, and commodity calculation as needed. The appropriate cost is divided into the DCC items 148 (combined or split as is needed for each contractor's cost code list). The resulting information from the manipulation of the bids provides for direct comparison of vendor bids in order to evaluate the winning bidder. The information can also be absorbed into the historical database 150 of bid information, rendering a set of costs that increases in accuracy with every valid bid received. The CDCCST units represent a takeoff system that will allow the vendor to adapt their unit cost in their takeoff routine to match the standardized takeoff units. When these alterations are synchronized the vendor can simplify his takeoff for all contractors using this system. The new vendor's bidding would consist of confirming unit cost and an overview of the takeoff before submitting their bid, cutting their bidding time to a fraction of what it currently is.

An “activity audit trail” is maintained linking all changes to the login information of every user. This information indicates the relationship, access type, and time stamp as well as the changes made. The access level of each individual is controlled by both the vendor and contractor.

A “plan room” 130 area is maintained to store imported plans, specifications, scopes of work for each DCC, contract language, DCC bid sheets, and contractors' DCC standardized takeoffs. View and downloads for project information is located here but there is no importation for any bids in this area. The only importation available to vendors in this area is “Requests For Information” (RFI).

A “contact maintenance” 128 area is used by the contractor to view and update access levels for each contact inside the contractor's company. The contractor's vendor selection 132 area is used by the contractor to view and update access levels for each contact inside the vendor's company. This will include access to planrooms and sending and receiving of bids and contracts.

A “data maintenance” 156 area is used to maintain, alter, and link contractor's cost codes to the systems “design cost codes”. If the contractor's cost code list has fewer codes than the DCC standardized list, the DCC will have to be grouped combining the takeoff and computation details under a single contractor's cost code name. The naming protocol 162 for this combination shall be called a “Design Cost Code Group” (DCCG). If the contractor's cost code list has more codes than the DCC standardized list, the DCC may have to be split into more designations for takeoff and computation details under multiple contractor's cost code names. The naming protocol for the splitting of DCC shall be called “Design Cost Code Pay Points” (DCCPP). The contractor's existing cost code names and numbers will be linked to the standardized list allowing the use of familiar names and numbers without reprograming for every contractor. In the Purchasing Service module 160 each contractor and his cost code 162 designations shall be maintained to allow the functioning of the system in a common language and data for each contractor to be delivered in the form they are accustomed to. Alterations of available options in the option library are accessed in this data maintenance area 156. The maintaining, altering, and linking of the standardized options are also done in this area. This maintenance is not the same as naming areas of the house and groupings found in the “Design Phase” 70 but are alterations of options in the library of options.

A “document and specifications maintenance” 164 area is used to maintain, alter, and link the descriptions of advertising language, sales contract option descriptions, purchasing option descriptions, DCC scope of work details, and contract versions. Linking the standardized language to the contractor's associated document language as mentioned above. In the Purchasing Service module 160 each contractor and his document language designations shall be maintained to allow the functioning of the system in a common language and data for each contractor to be delivered in the form they are accustomed to.

The “bidding process” 166 consists of an area to select vendors 132 that are allowed to bid on the various DCC for a project, track their progress in accessing data, and returning the bids 134. When competing bids are returned the unit cost will be standardized 182 they will be evaluated against each other and the budget. Winning bids will be used to set a contracted budget for each code. During the bidding process the bid tracking log 134 provides a location for keeping track of contact with the vendors as calls are made. This log is the report generated from the audit trail of the access to the planroom. It also allows results to be recorded when a call, e-mail or other contact is made to a vendor, by means of a dropdown list i.e., (busy, left message, contacted, or other). Sending and/or receiving results can be noted and records of conversations can be logged as backup for future negotiations. On completion of contract awards, the contracts can electronically signed 136,186 or signed by hand. The contractor billing 168,188 information for each winning bid is kept in a separate area with limited access restricted to each vendor and sortable by project. Each contract is dated and updateable according to the terms of the contract.

Vendor 152

The website of the Vendors Module 170 has two versions; the open access 172 allowing the vendors to bid on projects and the subscription version 174 to access the use of the full featured site.

The vendors open access will require a login. The vendor may alter contacts and other registration 62 information as needed. The logged-in vendor will proceed to the contractor's location 178 and gather information and bid on the project.

In the “bid submission process” for the vendors, the vendor will log into the contractors planroom 130 and go to the project location that they have been invited to bid on. They will download or view the plans, specifications, scope of work for their Design Cost Codes (DCC), and general contract documents. They will also download the “bid sheet” 180 for their DCC. The “Contractors Design Cost Code standardized takeoff' 148 for each cost code will be available (no prices, budgets, or costs will be viewable to any vendor). Vendors may access a takeoff area in the bid submission area 182 and prepare their bid submission.

Vendors will return the “bid sheet” 180 completed with their pricing and may also return the “Contractors Design Cost Code standardized takeoff” 148 if they wish to use the information provided. Bids will be returned by placing the bid sheet material with costs into the vendors bid submission log area 182 and they can than release it for the contractor's buyer to import 132. By keeping all the bid information on their site 184 access can be strictly controlled and monitored in the system. The bid sheet will interact with the base house selections to allow the vendor to view not only the full price of the bids 138 but also the billing sheet 122 for the current project.

If the vendor has been selected as the winning bidder or as one of the winning bidders, they will find their contract in their contract signing location 186 on their site. The contract can be E-signed and returned to the contractor where receipt can be confirmed and billing sheets posted 188 and confirmed by each party. Both the contractor 168 and vendor 188 should archive the contracts in there archive areas. The billing sheets with their respective confirmation check offs will be stored with limited access by both the contractor and vendor on their respective sites. The access to the planroom 130 for wider viewing by vendor's employees will be available after winning the bid.

In the subscription version the vendor will have access to three additional features: the takeoff area, the manufacturer's area, and the advertising to contractor's area.

Vendors may access a detailed takeoff area 192 and prepare their bid cost in any method 262 and detail desired. In the vendor detailed takeoff area 192 of the subscription version the vendor will have access to more filters and permissions regarding contact maintenance 184. The takeoff area will included features such as receiving the “bid sheets”, “contractors design cost code standardized takeoffs”, multi-level markups for different contractors, cross bid comparisons, and open bid data logs for competing vendor archives.

The vendor's area for manufacturers 54 allows for request for product quotes to be sent. Advertising from manufacturers to vendors can be included here.

The advertising area 190 for vendors allows for detailed advertising and company information to be sent to contractors, when requesting to be added to their bidders' lists.

Purchasing Service 66

The Purchasing Service module 258 can offer a selection of services to contractors and vendors to make their individual purchasing departments more efficient. This will require greater log-in flexibility 194 between the companies. Starting as early as the design phase, the purchasing service will mirror the contractors' process 196.

The purchasing service will need to access the back office 204 functions dealing with formula maintenance 158, import to DCC formulas 198, advertising maintenance 200, data feed 202, and cost code linkage 162.

Manufacturers 154

The Manufacturers module 206 will have access to advertising maintenance 208, advertising copy 210, a send and receive quotes service, and a database for vendor item quotes. The vendor quoting area 214 will provide takeoff functions similar to the vendor takeoff system 262.

Data Services 246

The Data Services module 216 will have access to upload data 218, maintenance of data 220,150, and monitoring usage for billing for services 222

Public Users 248

The Public Users' module will have access to the functional features of the system but will be presented through an alternative embodiment.

### DETAILED DESCRIPTION—ALTERNATIVE EMBODIMENT

We will describe the process from the viewpoint of the public user as they interact with each aspect of the system. The system and method of this embodiment, however, could easily be converted into use in any other industry where there is a need for uniformity, standardization and the other efficiencies of this system.

An embodiment of the system and method is the public use of the purchasing and bidding system. The other participants in this system are the vendors (including manufacturers, vendors, contractors, and suppliers of services such as legal, survey, home inspection, etc.). Also available in this system is advertising, and pricing products for the vendors. Data services are also provided that can alter formulas that update pricing, and other information as defined.

Public Users 248

Site setup for the public 226 will be in a similar format as seen in many retail websites 228. The website will offer instructions on the use of the system in an interactive format. Product advertising of a limited nature will be offered on the pre-login pages. Blogs and advertising from manufacturers 240 will be located here as well.

Post login advanced registration 62 is available to provide more detail if desired, but limited information is all that is needed to start. The website offers product areas in all aspects of construction and also products that are related from pre-and-post construction activities to supplementary services. After login, advertising, recommendations, and blogs relating to the vendors and contractors are available.

The public users' pages 226 offer interaction with all the features mentioned above and more. The primary usability is the same for public users as outlined for the contractors 64 in the first embodiment, i.e. the answering of questions to describe the house or aspect of the remodel of an existing house 230. This public's use of the system may encompass not only the products described in the first embodiment, but also offers other types of products. When the product is described to the best extent desired by the public user a “view budget” 232 feature will be available. As with the first embodiment described, the budget will have the full functionality behind the budget, including scope, specifications, DCC, etc. 234,164, and the full routine for vendor bidding (with the exception of the planroom until standardized plan sets are developed and offered as a further embodiment of the system). When the public user feels he would like the get actual bids the “request for quotes” (RFQ) 232 can be sent and vendors and contractors will have the full description with contract language, scope, and product descriptions 234. If the public user was lax in the project description the system will use its defaults to fully describe the offering for quoting the project 238. When the bids are returned the public user can research the contractor's or vendors' 236 history. The public user can then select vendors using the detailed project description, scope, and contracts, and/or have the vendor visit the site to make adjustments as needed as they move ahead with their project.

The full design system, DCC bidding, and vendor selection is available to be used in the public users' system. The vendors have the full functionality 238 in both environments should they wish to make use of the offerings.

1. A method and data processing system for managing a product design, preparation to receive a bid for the product, retrieving bid information, processing the bids, and updating costs and other details for purchasing the product:
a. computer processor means a personal computer or internet based system including central processing units for processing data;
b. storage means a data disk held at any location for storing data on a storage medium;
c. an arithmetic logic circuit configured to prepare the data disk to magnetically store selected data for initializing the storage medium.

2. An arithmetic logic circuit configured to retrieve information from data entered either manually or by means of complementary programs, to configure project design data and/or takeoffs, to attach said data to design cost codes that will provide information that is manipulated and processed into the system preparing in part the request for quote information.

3. An arithmetic logic circuit configured to retrieve information from entered data either manually or by means of complementary programs, to link, configure, store, and retrieve information that will connect the different cost codes of contractors to the system's design cost codes and manipulate and process said data into the system.

4. An arithmetic logic circuit configured to retrieve information from specific files in the bids received, calculate entries, increases, and/or decreases based on the specific input, allocate the results to the system's design cost codes and compare and alter the other design data as required, then store the output in separate files for processing the new data into each of the program functions as is required.

5. An arithmetic logic circuit configured to retrieve information from specific storage sources, calculate incremental increases and/or decreases based on specific data inputs, allocate the results on a percentage or other basis and store the output in separate files for processing; data updating can be based on new incoming information from data services that may provide information as to location, time, commodity pricing, manufactures information and or other factors as may be required.

6. Based on bid data collected and changes made in option configurations, an arithmetic logic circuit configured to retrieve billing information from specific storage sources, re-calculate that information, and store the output in separate files for processing, changing, and reviewing of automated billings.
